(19) United States
(12) Patent Application Publication
(10) Pub. No.: US 2010/0235169 A1
(43) Pub. Date: Sep. 16, 2010

(54) SPEECH DIFFERENTIATION

(75) Inventor: Aki Sakari Harma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/302,297

(22) PCT Filed: May 15, 2007
(86) PCT No.: PCT/IB07/51845

§ 371 Date: Nov. 25, 2008

(30) Foreign Application Priority Data
Jun. 2, 2006 (EP) 06114887.0

(51) Int. Cl. G10L 15/00

(52) U.S. Cl. 704/246; 704/E15.001

(57) ABSTRACT

Method for differentiation between voices including 1) analyzing perceptually relevant signal properties of the voices, e.g. average pitch and pitch variance, 2) determining sets of parameters representing the signal properties of the voices, and finally 3) extracting voice modification parameters representing modified signal properties of at least some of the voices. Hereby it is possible to increase a mutual parameter distance between the voices, and thereby the perceptual difference between the voices, when the voices have been modified according to the voice modification parameters. Preferably most of or all voices are modified in order to limit the amount of modification of one parameter. Preferred signal property measures are: pitch, pitch variance over time, glottal pulse shape, formant frequencies, signal amplitude, energy differences between voiced and un-voiced speech segments, characteristics related to overall spectrum contour of speech, characteristics related to dynamic variation of one or more measures in long speech segment. The method allows an automatic voice differentiation with a natural sound since it is based on a modification of signal properties determined for each of the voices.

The present invention relates to the field of signal processing, especially processing of speech signals. More specifically, the invention relates to a method for differentiation between first and second voices and to a signal processor and a device for performing the method.

Differentiation of the voices of different speakers is a well-known problem e.g. in telephony and in teleconference systems. E.g. in a teleconference system without visual cues, a remote listener will have difficulties following a discussion among a number of speakers simultaneously speaking. Even if only one speaker is speaking, the remote listener may have difficulties identifying the voice and thus identifying who is speaking. In mobile telephony in noisy environments speaker identification may also be problematic, especially due to the fact that regular callers due to close genetic and/or socio-linguistic relations tend to have similar voices. In addition in virtual workplace applications where a line is open for several speakers, quick and precise speaker identification may be important.

US 2004/0013252 describes a method and apparatus for improving listener differentiation of talkers during a conference call. The method uses a signal transmitted over a telecommunication system, and the method includes the voice from each one of the plurality of talkers to the listener, and an indicator indicates the actual talker to the listener. US 2004/0013252 mentions different modifications of the original audio signal in order to better allow the listener to distinguish between talkers. E.g. spatial differentiation, where each individual talkers are rendered to different apparent directions in auditory space, e.g. by using binaural synthesis such as applying different Head Related Transfer Function (HRTF) filters to the different talkers. The motivation for this is the observation that speech signals are easier to understand if the speakers appear in different directions. In addition, US 2004/0013252 mentions that similar voices can be slightly altered in various ways to assist in the voice recognition by the listener. A “nasaling” algorithm based on frequency modulation so as to provide a slight frequency shift of one of the speaker's voice is mentioned to allow a better differentiation of the voice from another speaker's voice.

The speech differentiation solutions proposed in US 2004/0013252 have a number of disadvantages. In order for the spatial separation between speakers, such method requires two or more audio channels in order to provide the listener with the required spatial impression, and thus such methods are not suited for applications where only one audio channel is available, e.g. in normal telephony systems such as in mobile telephony. The “nasaling” algorithm mentioned in US 2004/0013252 can be used in combination with the spatial differentiation method. However, the algorithm produces unnatural sounding voices and if used to differentiate between a number of similar voices, it does not improve differentiation because all modified voices get a perceptually similar ‘nasal’ quality. In addition, US 2004/0013252 provides no means for automatic control of the ‘nasaling’ effect by the properties of the speakers' voices.

Hence, it is an object to provide a method that is capable of automatically processing speech signals with the purpose of assisting a listener in immediately identifying a voice e.g. a voice heard in a telephone, i.e. assisting the listener differentiating between a number of known voices.

This object and several other objects are obtained in a first aspect of the invention by providing a method for differentiation between first and second voices, the method comprising the steps of

1) analyzing signal properties of first and second speech signals representing the respective first and second voices,
2) determining respective first and second sets of parameters representing measures of the signal properties of the respective first and second speech signals,
3) extracting a voice differentiating template adapted to control a voice modification algorithm, the voice differentiating template being extracted so as to represent a modification of at least one parameter of at least the first set of parameters, wherein the modification serves to increase a mutual parameter distance between the first and second voices upon processing by the modification algorithm controlled by the voice differentiating template.

By “voice differentiating template” is understood a set of voice modification parameters for input to the voice modification algorithm in order to control its voice modification function. Preferably, the voice modification algorithm is capable of performing modification of two or more voice parameters, and thus the voice differentiating template preferably includes these parameters. The voice differentiating template may include different voice modification parameters assigned to each of the first and second voices, and in case of more than two voices, the voice differentiating template may include voice modification parameters assigned to a subset of the voices or to all voices.

According to this method it is possible to automatically analyze a set of speech signals representing a set of voices and arrive at one or more voice differentiating templates assigned to one or more of the set of voices based on properties of features of the voices. By applying associated voice modification algorithms accordingly, individually for each voice, it is possible to produce the voices with a natural sound but with increased perceptual distance between the voices thus helping the listener differentiating between the voices.

The effect of the method is that voices can be made more different while still preserving a natural sound of the voices. This is possible also if the method is performed automatically, due to the fact that the voice modification template is based on signal properties, i.e. characteristics of the voices themselves. Thus, the method will seek to exaggerate existing differences or artificially increase perceptually relevant differences between the voices rather than applying synthetic sounding effects.

The method can either be performed separately for an event, e.g. a teleconference session, where voice modification parameters are selected individually for each participant for the session. Alternatively it can be a persistent setting of voice modification parameters for individual callers, where the voice modification parameters are stored in a device associated with each caller's identity (e.g. phone number), e.g. stored in a phonebook of a mobile phone.

Since the method described only needs as input a single channel audio signal and since it is capable of functioning with a single output channel, the method is applicable e.g. within a wide range of communication applications, e.g. telephony, such as mobile telephony or Voice over Internet Protocol based telephony. Naturally, the method can also be directly used in stereophonic or multi-channel audio communications systems.

Preferably, the voice differentiating template is extracted so as to represent a modification of at least one parameter of both of the first and second sets of parameters. Thus, preferably both the first and second voices are modified, or in general it may be preferred that the voice differentiating template is extracted so that all voices input to the method are modified with respect to at least one parameter. However, the method may be arranged to exclude modifying two voices in case a mutual parameter distance between the two voices exceeds a predetermined threshold value.

Preferably, the voice differentiating template is extracted so as to represent a modification of two or more parameters of at least the first set of parameters. It may be preferred to modify all of the parameters in the set of parameters. Thus, by modifying more parameters it is possible to increase a distance between two voices without the need to modify one parameter of a voice so much that it results in an unnatural sounding voice.

The same applies to a combination with the above-mentioned sub aspect of extracting the differentiating template such that more of, and possibly all of, the voices are modified. By modifying at least a large portion of parameters for a large portion of the voices, it is possible to obtain a mutual perceptual distance between the voices without the need to modify any parameter of any voice so much that it leads to an unnatural sound.

Preferably, the measures of the signal properties of the first and second speech signals represent perceptually significant attributes of the signals. Most preferably the measures include at least one measure, preferably two or more or all of the measures selected from the group consisting of: pitch, pitch variance over time, formant frequencies, glottal pulse shape, signal amplitude, energy differences between voiced and un-voiced speech segments, characteristics related to overall spectrum contour of speech, characteristics related to dynamic variation of one or more measures in long speech segment.

Preferably step 3) includes calculating the mutual parameter distance taking into account at least part of the parameters of the first and second sets of parameters, and wherein the type of distance calculated is any metric characterizing differences between two parameter vectors, such as the Euclidean distance, or the Mahalanobis distance. While the Euclidean type of distance is a simple type of distance, the Mahalanobis type of distance is an intelligent method that takes into account variability of a parameter, a property which is advantageous in the present application. However, it is appreciated that a distance can in general be calculated in numerous ways. Most preferably, the mutual parameter distance is calculated taking into account all of the parameters that are determined in step 1). It is appreciated that calculating the mutual parameter distance in general is a problem of calculating a distance in n-dimensional parameter space, and as such any method capable of obtaining a measure of such distance may in principle be used.

Step 3) may be performed by providing modification parameters based on one or more of the parameters for the one or more voices such that a resulting predetermined minimum estimated mutual parameter distance between the voices is obtained. Preferably, the parameters representing the measures of signal properties are selected such that each parameter corresponds to a parameter of the voice differentiating template.

Optionally, the method includes analyzing signal properties of a third speech signal representing a third voice, determining a third set of parameters representing measures of the signal properties of the third speech signal, and calculating a mutual parameter distance between the first and third set of parameters. It is appreciated that the teaching according to the first aspect in general is applicable for carrying out on any number of input speech signals.

Optionally, the method may further include the step of receiving a user input and adjusting the voice differentiating template according thereto. Such user input may be user preferences, e.g. the user may input information not to apply voice modification to the voice of his/her best friend.

Preferably, the voice differentiating template is arranged to control a voice modification algorithm providing a single audio output channel. However, if preferred the method may be applied in a system with two or more audio channels available and thus the method may be used in combination, e.g. serve as input to, a spatial differentiating algorithm such as known in the art further and thereby obtain a further voice differentiation.

Preferably, the method includes the step of modifying an audio signal representing at least the first voice by processing the audio signal with a modification algorithm controlled by the voice differentiating template and generating a modified audio signal representing the processed audio signal. The modification algorithm may be selected from the voice modification algorithms known in the art.

All of the mentioned method steps may be performed at one location, e.g. in one apparatus or devices, including the step of running the modification algorithm controlled by the voice differentiating template. However, it is appreciated also that e.g. at least steps 1) and 2) may be performed at a location remote to the step of modifying the audio signal. Thus, the steps 1), 2) and 3) may be performed on a persons's Personal Computer. The resulting voice differentiating template can then be transferred to another device such as the person's mobile phone, where the step of running the modification algorithm controlled by the voice differentiating template is performed.

Steps 1) and 2) may be performed either on-line or off-line, i.e. either with the purpose of immediately performing step 3) and performing a subsequent voice modification, or steps 1) and 2), and possibly 3), may be performed on a training set of audio signals representing a number of voices for later use.

In on-line applications of the method, e.g. teleconference applications, it may be preferred that steps 1), 2) and 3) are performed adaptively in order to adapt to long term statistics of the signal properties of the involved person's voices. In on-line applications, e.g. teleconferences, it may be preferred to add an initial voice recognition step in order to be able to separate several voices contained in a single audio signal transmitted on one audio channel. Thus, in order to provide input to the voice differentiating method described, voice recognition procedure can be used to split up an audio signal into part which includes only one voice each, or at least predominantly only one voice each.

In off-line applications it may preferred to run at least step 1) on long training sequences of speech signals in order to be able to take into account long term statistics of the voices. Such off-line applications may be e.g. during preparation of a voice differentiating template with modification parameters assigned to each telephone number of a person's telephone book which will allow a direct selection of a proper voice modification parameter for a voice modification algorithm upon a telephone call being received from a given telephone number.

It is appreciated that any two or more of the above-mentioned embodiments or sub aspects of the first aspect may be combined in any way.

In a second aspect, the invention provides a signal processor comprising

a signal analyzer arranged to analyze signal properties of first and second speech signals representing respective first and second voices,

a parameter generator arranged to determine respective first and second sets of parameters representing at least measures of the signal properties of the respective first and second speech signals,

a voice differentiating template generator arranged to extract a voice differentiating template adapted to control a voice modification algorithm, the voice differentiating template being extracted so as to represent a modification of at least one parameter of at least the first set of parameters, wherein the modification serves to increase a mutual parameter distance between the first and second voices upon processing by the modification algorithm controlled by the voice differentiating template.

It is appreciated that the same advantages and the same type of embodiments described for the first aspects apply also for the second aspect.

The signal processor according to the second aspect preferably includes a signal processor unit and associated memory. The signal processor is advantageous e.g. for integration into stand-alone communication devices, however it may also be a part of a computer or a computer system.

In a third aspect the invention provides a device comprising a signal processor according to the second aspect. The device may be a voice communication device such as a telephone, e.g. a mobile phone, a Voice over Internet Protocol based communication (VoIP) device or a teleconference system. The same advantages and embodiments as mentioned above apply to the third aspect as well.

In a fourth aspect, the invention provides a computer executable program code adapted to perform the method according to the first aspect. The program code may be a general computer language or a signal processor dedicated machine language. The same advantages and embodiments as mentioned above apply to the fourth aspect as well.

In a fifth aspect, the invention provides a computer readable storage medium comprising a computer executable program code according to the fourth aspect. The storage medium may be a memory stick, a memory card, it may be disk-based e.g. a CD, a DVD or a Blueray based disk, or a harddisk e.g. portable harddisk. The same advantages and embodiments as mentioned above apply to the fifth aspect as well.

It is appreciated that advantages and embodiments mentioned for the first aspect also apply for the second, third and fourth aspects of the invention. Thus, it is appreciated that any one aspect of the present invention may each be combined with any of the other aspects.

The present invention will now be explained, by way of example only, with reference to the accompanying Figures, where

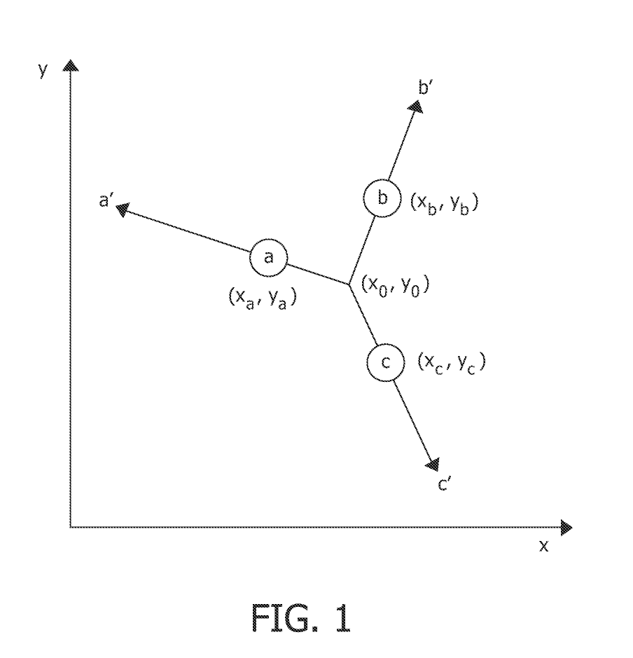

FIG. 1 illustrates an embodiment of the method applied to three voices using two parameters representing signal property measures of the voices, and

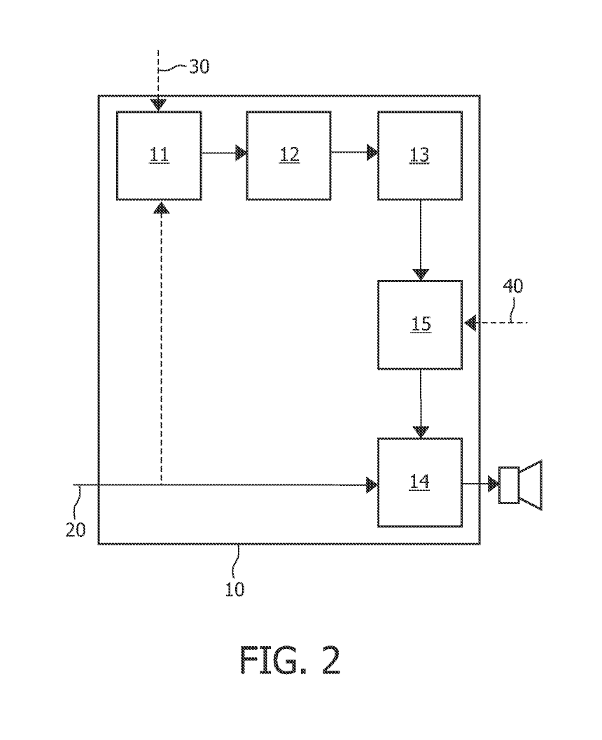

FIG. 2 illustrates a device embodiment.

FIG. 1 illustrates location a, b, c of three speakers's A, B, C voices, e.g. three participants of a teleconference, where the location a, b, c in the x-y plane is determined by parameters x and y reflecting measures relating to signal properties of their voices, for example parameter x can represent fundamental frequency (i.e. average pitch), while parameter y represents pitch variance. In the following, a preferred function of a speech differentiating system is explained based on this example.

For simplicity it is assumed that three original speech signals from participants A, B, and C are available for the speech differentiation system. Then, based on these signals, a signal analysis is performed, and based thereon a set of parameters (xₐ, yₐ) has been determined for the voice of the person A, representing signal properties in the x-y plane of person A's voice, and in a similar manner for persons B and C. This is done by a pitch estimation algorithm which is used to find the pitch from voiced parts of speech signals. The system collects statistics of pitch estimates including the mean pitch and the variance of pitch over some predefined duration. At a certain point, typically after a few minutes of speech from each participant, it is determined that the collected statistics are sufficiently reliable for making comparison between voices. Formally, this may be based on statistical arguments such as the collected statistics of pitch for each speaker corresponds to a Gaussian distribution with some mean and variance with a certain predefined likelihood.

Next, the comparison of the speech signals is illustrated in FIG. 1. In this example it is assumed, that the speakers's A, B, C voices are relatively close to each other in terms of the two parameters x, y.

Thus it is desired to extract a voice differentiating template to be used for performing a voice modification on the speaker's voices in the teleconference, or in other words provide a mapping in the x-y-plane which makes the speakers more distinct in terms of these parameters—or where a mutual parameter distance between their modified voices is larger than a mutual parameter distance between their original voices.

In this example, the mapping is based on elementary geometric considerations: each speaker A, B, C is moved further away from a center point (x₀, y₀) along a line crossing the center point and the original position to modified positions a′, b′, c′, i.e. positions. The center point can be defined in many ways. In the current example, it is defined as the barycenter (center of gravity) of the positions of the speakers A, B, C given by

$$( {x}_{0} , {y}_{0} ) = ( \frac{1}{K} {\sum }_{k} {x}_{k} , \frac{1}{K} {\sum }_{k} {y}_{k} ) ,$$

where K is the number of speakers. We may represent the modification as a matrix operation in the homogenous coordinates using the following notation. Let us define a vector representing the location of a talker k:

vₖ=[xₖyₖ1]^{T}

To change the positions by vector multiplication it is convenient to move the center point first to the origin. The barycenter may be moved to the origin by the following mapping:

$${v}_{k}^{′} = [ \begin{matrix}1 & 0 & {x}_{0} \\ 0 & 1 & {y}_{0} \\ 0 & 0 & 1\end{matrix} ] {v}_{k} = {Av}_{k} = {[ \begin{matrix}{x}_{k}^{′} & {y}_{k}^{′} & 1\end{matrix} ]}^{T}$$

The modification of the parameters can then be performed as a matrix multiplication

$${m}_{k}^{′} = [ \begin{matrix}{λ}_{x} & 0 & 0 \\ 0 & {λ}_{y} & 0 \\ 0 & 0 & 1\end{matrix} ] {v}_{k}^{′} = {Mv}_{k}^{′} .$$

When the values of the multipliers λₓ and λ_{y} are larger that one it holds that the distances between any two modified talkers, say, m′ᵢ and m′ⱼ, is larger than the distance between the original parameters v′ᵢ and v′ⱼ. The magnitude of the modification (the distance between the original position and the position of the modified voice) depends on the distance of the original point from center point and for a talker exactly in the center point the mapping has no effect. This is a beneficial property of the method because the center point can be chosen such that it is exactly at the location of a certain person, e.g., a close friend, thus leaving his/her voice unmodified.

In order to implement the modification it is necessary to shift the modified parameters back to the neighborhood of the original center point. This can be performed by multiplying each vector by the inverse of the matrix A, denoted A⁻¹. To summarize, the operation of moving the parameters of K speakers further away from each other relative to a center point (x₀, y₀) can be written as a single matrix operation:

[m₁m₂ . . . m_{K}]=A⁻¹MA[v₁v₂ . . . v_{K}] (1)

The matrix expression of (1) generalizes directly to the multidimensional case where each speaker is represented by a vector of more than two parameters.

In the current example, the voice differentiating template includes parameters that will imply that the average pitch of speakers B and C is increased but the pitch of speaker A is decreased, when voice modification algorithm is performed controlled with the voice differentiating template. However, at the same time the variance of pitch of speakers A and B are increased while the variance of the pitch of C is decreased causing speaker C sound as a more monotonous speaker.

In general, it may be such that only some of the speakers have voice parameters so close to each other that modification is necessary. Thus, in such cases a speech modification algorithm should only be applied only to the subset of speakers having voices with a low mutual parameter distance. Preferably, such mutual parameter distance expressing the similarity between speakers is determined by calculating a Euclidean or a Mahalanobis distance between the speakers in the parameter space.

In the voice differentiating template extraction it is possible to have more than one center points. For example, separate center points could be determined for low and high-pitched talkers. The center point may be determined by many alternative ways other than computing the center of gravity. For example, the center point may be predefined position in the parameter space based on some statistical analysis of the general properties of speech sounds.

In the above example, a simple multiplication of the parameter vectors is used to provide the voice differentiating template. This is an example of a linear modification, however alternatively the modification of the parameters can also be performed using other types of linear or non-linear mapping.

Modification of speech signals may be based on several alternative techniques addressing different perceivable attributes of speech signals, and combinations of those. The pitch is an important property of a speech signal. It can also be measured from voiced parts of signals and also modified relatively easily. Many other speech modification techniques change the overall quality of a speech signal. For simplicity various such changes are called timbral changes as they can often be associated with the perceived property of the timbre of a sound. Finally, it is possible to control speech modification in a signal-dependent manner such that the effects are controlled separately for different for parts of the speech signal. These effects often change the prosodic aspects of speech sounds. For example, dynamic modification of the pitch changes the intonation of speech.

In essence, the preferred methods for the differentiation of speech sounds can be seen as including analyzing the speech using meaningful measures characterizing perceptually significant features, comparing the values of the measures are compared between individuals, defining a set of mappings which makes the voices more distinct, and finally performing voice or speech modification techniques implement the defined changes to the signals.

The time scale for the operation of the system may be different in different applications. In typical mobile phone use one possible scenario is that the statistics of analysis data are collected over a long period of time and it is connected to individual entries of the phonebook of stored in the phone. The mapping of the modification parameters is also performed dynamically over time, e.g., by some regular intervals. In a teleconference application, the modification mapping could be derived separately for each session. The two ways of temporal behavior (or learning) can also co-exist.

The analysis of input speech signals is naturally related to the signal properties that can be modified by the speech modification system used in the application. Typically those may include pitch, variance of the pitch over a longer period of time, formant frequencies, or energy differences between voiced and unvoiced parts of speech.

Finally, each speaker is associated with a set of parameters for the speech or voice modification algorithm or system. The desired voice modification algorithm is out of the scope of the present invention, however several techniques are known in the art. In the example above, voice modification is based on a pitch-shifting algorithm. Since it is required to modify both the average pitch and the variance of pitch it is necessary to control the pitch modification by a direct estimate of the pitch from the input signal.

The methods described are advantageous for use in Voice over Internet Protocol based communication where it is widespread that users do not necessarily close the connection when they stop talking. The audio connection becomes a persistent channel between two homes and the concept of telephony session vanishes. People connected to each other may just leave the room to do some other things and possibly return later to continue the discussion, or just use it to say ‘good night!’ in the evening when going to sleep. Thus, a user may have several simultaneous audio connections open where the identification of a talker naturally becomes an issue. In addition, when the connection is continuously open, it is not normal to follow the traditional identification practices of the traditional telephony, where a caller usually presents himself every time the user wants to say something.

It may be preferred to provide a predetermined maximum magnitude of modification for each of the analyzed parameter of the voices in order to limit the amount of modification for each parameter to a level which does not result in an unnatural sounding voice.

To summarize the preferred method, it includes analyzing perceptually relevant signal properties of the voices, e.g. average pitch and pitch variance, determining sets of parameters representing the signal properties of the voices, and finally extracting voice modification parameters representing modified signal properties of at least some of the voices in order to increase a mutual parameter distance between them, and thereby the perceptual difference between the voices, when the voices have been modified by the modification algorithm.

FIG. 2 illustrates a block diagram of a signal processor 10 of a preferred device, e.g. a mobile phone. A signal analyzer 11 analyses speech signals representing a number of different voices with respect to a number of perceptually relevant measures. The speech signals may originate from a recorded set of signals 30 or it may be based on an audio part 20 of an incoming call. The signal analyzer 11 provides analysis results to a parameter generator 12 that generates in response a set of parameters for each voice representing the perceptually relevant measures. These set of parameters are applied to a voice differentiating template generator 13 that extracts a voice differentiating template accordingly, the voice differentiating template generator operating according to what is described above.

The voice differentiating template can of course be directly applied to a voice modifier 14, however in FIG. 2 it is illustrated that the voice differentiating template is stored in memory 15, preferably together with a telephone number associated with the person to who the voice belongs. Then the relevant voice modification parameters can be retrieved and input to the voice modifier 14 such that the relevant voice modification is performed on the audio part 20 of an incoming call. The output audio signal from the voice modifier 14 is then presented to the listener.

In FIG. 2 the dashed arrow 40 indicates that alternatively, a voice differentiating template generated on a separate device, e.g. on a Personal Computer or another mobile phone, may be input to the memory 15, or directly to the voice modifier 14. Thus, once a person has created a voice differentiating template for a phonebook of friends, this template can be to transferred to the person's different communication devices.

It is appreciated that the methods described in the foregoing can be used in several other products related to voice communications than those specifically described.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.1.

1. Method for differentiation between first and second voices, the method comprising the steps of
1) analyzing signal properties of first and second speech signals representing the respective first and second voices,
2) determining respective first and second sets of parameters representing measures of the signal properties of the respective first and second speech signals,
3) extracting a voice differentiating template adapted to control a voice modification algorithm, the voice differentiating template being extracted so as to represent a modification of at least one parameter of at least the first set of parameters, wherein the modification serves to increase a mutual parameter distance between the first and second voices upon processing by the modification algorithm controlled by the voice differentiating template.

2. Method according to claim 1, wherein the voice differentiating template is extracted so as to represent a modification of at least one parameter of both of the first and second sets of parameters.

3. Method according to claim 1, wherein the voice differentiating template is extracted so as to represent a modification of two or more parameters of at least the first set of parameters.

4. Method according to claim 1, wherein the measures of the signal properties of the first and second speech signals represent perceptually significant attributes of the signals.

5. Method according to claim 4, wherein the measures include at least one measure selected from the group consisting of: pitch, pitch variance over time, glottal pulse shape, signal amplitude, formant frequencies, energy differences between voiced and un-voiced speech segments, characteristics related to overall spectrum contour of speech, characteristics related to dynamic variation of one or more measures in long speech segment.

6. Method according to claim 1, wherein step 3) includes calculating the mutual parameter distance taking into account at least part of the parameters of the first and second sets of parameters, and wherein the type of distance calculated is selected from the group consisting of: Euclidian distance, and Mahalanobis distance.

7. Method according to claim 1, further including the steps of analyzing signal properties of a third speech signal representing a third voice, determining a third set of parameters representing measures of the signal properties of the third speech signal, and calculating a mutual parameter distance between the first and third set of parameters.

8. Signal processor (10) comprising:
a signal analyzer (11) arranged to analyze signal properties of first and second speech signals (20, 30) representing respective first and second voices,
a parameter generator (12) arranged to determine respective first and second sets of parameters representing at least measures of the signal properties of the respective first and second speech signals (20, 30),
a voice differentiating template generator (13) arranged to extract a voice differentiating template adapted to control a voice modification algorithm, the voice differentiating template being extracted so as to represent a modification of at least one parameter of at least the first set of parameters, wherein the modification serves to increase a mutual parameter distance between the first and second voices upon processing by the modification algorithm controlled by the voice differentiating template.

9. Signal processor (10) according to claim 8, wherein the voice differentiating template generator (13) is arranged to extract the voice differentiating template so as to represent a modification of at least one parameter of both of the first and second sets of parameters.

10. Signal processor (10) according to claim 8, wherein the voice differentiating template generator (13) is arranged to extract the voice differentiating template so as to represent a modification of two or more parameters of at least the first set of parameters.

11. Signal processor (10) according to claim 8, wherein the measures of the signal properties of the first and second speech signals represent perceptually significant attributes of the signals.

12. Signal processor (10) according to claim 11, wherein the parameter generator (12) is arranged to include at least one measure selected from the group consisting of: pitch, pitch variance over time, glottal pulse shape, signal amplitude, formant frequencies, energy differences between voiced and un-voiced speech segments, characteristics related to overall spectrum contour of speech, characteristics related to dynamic variation of one or more measures in long speech segment.

13. Signal processor (10) according to claim 8, wherein the voice differentiating template generator (13) includes calculating the mutual parameter distance taking into account at least part of the parameters of the first and second sets of parameters, and wherein the type of distance calculated is selected from the group consisting of: Euclidian distance, and Mahalanobis distance.

14. Signal processor (10) according to claim 8, wherein the signal analyzer (11) is further arranged to analyze signal properties of a third speech signal representing a third voice, wherein the parameter generator (12) is arranged to generate a third set of parameters representing measures of the signal properties of the third speech signal, and wherein the voice differentiating template generator (13) is arranged to calculate a mutual parameter distance between the first and third set of parameters.

15. Device comprising a signal processor (10) according to claim 8.

16. Computer executable program code adapted to perform the method according to claim 1.

17. Computer readable storage medium comprising a computer executable program code according to claim 16.
